(19) United States
(12) Patent Application Publication
(10) Pub. No.: US 2025/0375269 A1
(43) Pub. Date: Dec. 11, 2025

(54) POSTERIOR BITE INTERFERENCE ELEMENTS

(71) Applicant: Institut Straumann AG, Basel (CH)

(72) Inventors: Matthew Kossol, Round Rock, TX (US); Paul Dinh, Round Rock, TX (US); Alain Hedinger, Basel (CH)

(73) Assignee: Institut Straumann AG, Basel (CH)

(21) Appl. No.: 18/877,150

(22) PCT Filed: Mar. 28, 2024
(86) PCT No.: PCT/IB2024/053051

§ 371 Date: Dec. 19, 2024

Related U.S. Application Data
(60) Provisional application No. 63/456,085, filed on Mar. 31, 2023.

(51) Int. Cl. A61C 7/36; A61C 7/00

(52) U.S. Cl. CPC A61C 7/36; A61C 7/002

(57) ABSTRACT

The present disclosure discusses techniques for fabricating bite interference elements within polymeric dental appliances. The techniques disclose at least one polymeric shell that includes a number of cavities shaped to fit over a patient's teeth. The polymeric shell includes an occlusal appliance surface shaped to fit over an occlusal tooth surface of the patient. One or more bite interference elements are formed within the occlusal appliance surface, and each bite interference element includes a partially disc-shaped feature extending radially away from the occlusal tooth surface when worn by the patient.

### CROSS-REFERENCE TO RELATED APPLICATION

This application claims priority to and the benefit of U.S. Provisional Application Ser. No. 63/456,085, entitled “Posterior Bite Interference Elements” and filed Mar. 31, 2023, the content of which are hereby incorporated by reference in its entirety.

### FIELD OF THE TECHNOLOGY

The present technology relates to dental appliance manufacturing techniques. More specifically, this technology relates to techniques for forming bite interference elements on polymeric dental appliances.

### BACKGROUND

Orthodontic aligners are appliances intended to make a series of discrete tooth position corrections aimed at aligning the teeth correctly. Aligners have many advantages over traditional bracket/wire braces for orthodontic treatment. For example, aligners are often transparent or semi-transparent, more comfortable than wire braces, and are removable for cleaning and for eating. The manufacture of aligners traditionally begins with generating a digital model of the patient's teeth, either by scanning the patient's teeth, or by making a dental impression of the patient's teeth and then scanning the impression. Once a digital model of the patient's teeth has been acquired, physical dental models can be fabricated (e.g., using 3D printing techniques) to provide a positive model of the teeth.

When an intra-oral scanning device (IOS device) is used to scan a patient's teeth, three-dimensional computer aided design (CAD) representations can be imported by custom software. The custom software allows the operator, such as a dental technician or dentist, to move individual teeth in specific and discrete movements and in a number of stages according to a treatment plan to achieve the final dental arch of aligned teeth.

For each stage of a patient's treatment plan, a 3D printed model of the dental arch is fabricated, and a polymer sheet can be thermoformed over the top of the 3D printed arch model to form the clear aligner.

The thermoformed part is then marked with part identification. The marked and thermoformed part is then cut by one of several methods so that the aligner that goes to the customer can be separated from the excess aligner material.

The aligner is then polished to remove burrs and sharp edges, inspected, and then packaged to be shipped to the patient's orthodontist, or directly to the patient.

### SUMMARY

The present technology relates to techniques for forming bite interference elements on orthodontic appliances, such as transparent or semitransparent aligners, dental splints, retainers, etc. These orthodontic appliances can be made of a polymer material, and can be manufactured using a thermoforming or direct manufacturing (3D printing or other additive manufacturing) process, in some embodiments. Some advantages of the present disclosure include the ability to integrally form bite interference elements, or bite blocks on the occlusal surfaces of orthodontic appliances to prevent full closure of a patient's bite.

According to one aspect of the present disclosure, a dental appliance is disclosed that includes a polymeric shell with a number of cavities shaped to fit over a patient's teeth. The polymeric shell includes an occlusal appliance surface shaped to fit over an occlusal tooth surface. The appliance also includes bite interference elements formed in the occlusal appliance surface, with each bite interference element including a partially disc-shaped feature extending radially away from the occlusal tooth surface when worn by a patient. In some embodiments, the bite interference elements provide a displacement between upper and lower teeth when worn by the patient. In some embodiments, the bite interference elements include three partially disc-shaped features positioned in the occlusal appliance surface corresponding to a single molar or premolar. In some embodiments, each bite interference element is spaced between about 1.0 mm and 3.0 mm apart. In some embodiments, each bite interference element has an apex located in a single plane. In some embodiments, the partially disc-shaped feature of each bite interference element bas a diameter of between about 3.5 mm to 4.5 mm. In some embodiments, the disc-shaped feature of each bite interference element has a width of between about 0.3 mm to 0.7 mm. In some embodiments, the bite interference elements include a number of bite interference elements formed in the occlusal appliance surface of adjacent teeth.

According to another aspect of the present disclosure, a method of forming a dental appliance is disclosed. The method includes positioning a virtual bite interference element on an occlusal surface of one or more teeth within a virtual three-dimensional (3D) model of a patient's dentition. Each virtual bite interference element includes a disc-shaped feature partially extending radially away from the occlusal surface. The method also includes fabricating a physical model of the patient's dentition based on the virtual 3D model. The physical model includes one or more model bite interference elements corresponding to the one or more virtual bite interference elements. The method also includes thermoforming a thermoplastic material over the physical model of the patient's dentition to form a dental appliance having one or more bite interference elements corresponding to the model bite interference elements. In some embodiments, fabricating the physical model of the patient's dentition includes 3D printing the physical model of the patient's dentition. In some embodiments, the bite interference elements provide a displacement between upper and lower teeth when worn by the patient. In some embodiments, the bite interference elements include three partially disc-shaped features positioned in an occlusal appliance surface corresponding to a single molar or premolar. In some embodiments, each virtual bite interference element is spaced between about 1.0 mm and 3.0 mm apart. In some embodiments, each virtual bite interference element has an apex located in a single plane. In some embodiments, each virtual bite interference element has a diameter of between about 3.5 mm to 4.5 mm. In some embodiments, each virtual bite interference element has a width of between about 0.3 mm to 0.7 mm. In some embodiments, positioning the virtual bite interference elements includes positioning a number of virtual bite interference elements in the occlusal surface of a number of adjacent teeth within the virtual 3D model. In some embodiments, positioning the virtual bite interference elements includes positioning a first set of virtual bite interference elements in the occlusal surface of a second molar and a second set of virtual bite interference elements in the occlusal surface of a first molar or premolar, where the second set of virtual bite interference elements extends beyond an occlusal surface of the first molar or premolar more than the second set of virtual bite interference elements extends beyond an occlusal surface of the second molar.

According to another aspect of the present disclosure, a system is disclosed that includes a dental appliance fabrication system for fabricating a dental appliance. The system also includes a computing system in communication with the dental appliance fabrication system. The computing system receives three-dimensional (3D) scan data representing a patient's dentition, and generates a virtual 3D model of the patient's dentition. The computing system also positions a virtual bite interference element on an occlusal surface of a tooth within the virtual 3D model of the patient's dentition. Each virtual bite interference element includes a disc-shaped feature partially extending radially away from the occlusal surface. The system also provides instructions to the dental appliance fabrication system to fabricate a dental appliance including model bite interference elements corresponding to the virtual bite interference elements. In some embodiments, the dental appliance fabrication system includes a three-dimensional (3D) printing system to fabricate a physical dental model of the virtual 3D dental model, and a thermoforming system to thermoform a thermoplastic over the physical dental model to form a dental appliance having bite interference elements corresponding to the model bite interference elements.

### BRIEF DESCRIPTION OF THE DRAWINGS

The technology will be more fully understood from the following detailed description taken in conjunction with the accompanying drawings, in which:

FIG. 1 shows an example digital model of a set of bite interference elements extending from a digital model of a patient's dentition, according to an embodiment of the present disclosure.

FIG. 2 shows an example digital model of a set of bite interference elements positioned on a posterior tooth, according to an embodiment of the present disclosure.

FIG. 3 shows example dimensions of a set of bite interference elements, according to an embodiment of the present disclosure.

FIG. 4 shows an example of a thermoformed dental appliance including a set of integrated posterior bite interference elements, according to an embodiment of the present disclosure.

FIG. 5 shows an example of a thermoformed dental appliance including multiple sets of bite interference elements on various teeth, according to an embodiment of the present disclosure.

FIG. 6 shows an example user interface for a treatment planning software for determining a size and position of bite interference elements, according to an embodiment of the present disclosure.

FIG. 7A shows an example digital model of a patient's dentition including multiple sets of bite interference elements, according to embodiments of the present disclosure.

FIG. 7B shows another example digital model of a set of bite interference elements, according to embodiments of the present disclosure.

FIG. 7C shows an example digital model of a tooth with a set of three bite interference elements, according to embodiments of the present disclosure.

FIG. 8, FIG. 9, FIG. 10, FIG. 11, FIG. 12, FIG. 13, FIG. 14, FIG. 15, FIG. 16, FIG. 17, FIG. 18, and FIG. 19 each show exemplary digital models of various bite interference element geometries, according to embodiments of the present disclosure.

FIG. 20 shows an example thermoformed dental appliance with bite interference elements undergoing stress testing, according to embodiments of the present disclosure.

FIG. 21 shows a graph of the deformation of different bite interference element geometries at different force levels, according to embodiments of the present disclosure.

FIG. 22 depicts a flow diagram of a method for fabricating an integrated posterior bite interference element, according to embodiments of the present disclosure.

FIG. 23, shows a schematic structural diagram of a computer system adapted to implement a computing system, according to embodiments of the present disclosure.

### DETAILED DESCRIPTION

The present disclosure relates to a method of forming dental appliances that include bite interference elements or bite blocks incorporated as an integral part of the appliance. In some cases, particular malocclusions (e.g., anterior crossbite, posterior crossbite, and open bite malocclusions) may require bite modification structures or features on the appliance at certain steps during the treatment plan. In some treatment plans, bite turbos or bite blocks are attached to a patient's teeth in order to maintain a particular distance between the upper and lower arches and sometimes prevent the patient from fully closing their teeth. Bite turbos that are attached to a patient's teeth, however, require an attachment and removal process and result in an object being temporarily fixed to the patient's teeth. Furthermore, it can be challenging to design appliances that properly fit over such bite turbos that are fixed to a patient's teeth. In order to overcome these challenges, the present techniques provide a dental appliance with integrated bite interference elements.

In one embodiment, the integrated bite interference elements disclosed herein are located on the posterior teeth and modify the patient's bite while being worn. In this way, the dental appliance can modify the patient's teeth according to the stages of their particular treatment plan, while also preventing the patient from fully closing their teeth at certain locations. The bite interference elements disclosed herein include particular geometric structures that are thermoformed onto the occlusal surface of one or both of the appliances that can provide a set jaw spacing while also maintaining structural integrity and resisting deformation in response to the user's bite force.

The dental appliances disclosed herein may be made of a polymeric material, such as a thin thermoformable material. In some cases, the dental appliances are thermoformed around a dental model of a patient's teeth. The thickness of the polymeric material is not particularly limited but should be of sufficient thickness to thermoform around a dental model. Preferably, the polymeric material is less than 5 mm thick. More preferably, the thickness of the polymeric material may be from about 0.05 to about 5 mm thick.

Examples of thermoforming materials include but are not limited to polyethylene terephthalate (PET), polyethylene terephthalate glycol (PETG), thermoplastic polyurethane (TPU), polyvinyl chloride (PVC), and other biocompatible polymers with suitable elasticity and plasticity for thermoforming.

The polymeric material can include, for example, a multilayer polymeric material such as those described in U.S. Pat. Nos. 10,549,511; 10,870,263; 10,987,907; 11,325,358; 10,946,630; US Patent Publication No. 2022/0118747; PCT Application No. PCT/US2020/065928; PCT Application No. PCT/US2022/025306; and Provisional U.S. Patent Application No. 63/354,998; all of which are incorporated by reference in their entirety.

A set of appliances may include two shells that can be worn over a patient's teeth. Due to the mechanical properties of the polymer material used to make the shells, material forces can be exerted onto one or more teeth, and these forces can be designed to gradually move the patient's teeth according to a treatment plan from an initial position to a desired position. Each set of appliances can correspond to a step within the treatment plan that can correspond to a certain amount of time the patient is intended to wear the particular set of appliances. Each set of appliances can differ slightly from the previous set in order to gradually move the teeth along the intended treatment plan path. The appliances can be described as having multiple cavities, with each cavity corresponding to a particular tooth within the patient's dental arch.

In some embodiments, within one or more of the steps of the treatment plan, or in other types of dental appliances (such as retainers), it may be desirable to prevent full closing of the patient's teeth. According to the techniques disclosed herein, this can be achieved by including bite interference elements, or bite blocks, on the lower and/or upper dental appliances. In some embodiments, posterior bite interference elements describe bite interference elements that are positioned on the molars or posterior teeth. Such posterior bite interference elements may also work to increase molar intrusion performance in some cases.

FIG. 1 shows an example digital model of a set of bite interference elements 101 extending radially from a digital model of a patient's dentition 103, according to an embodiment of the present disclosure. In this embodiment, the digital model of the bite interference elements includes three disc or coin-shaped protrusions that extend radially from the occlusal surface of one of the molars. In the digital model shown in FIG. 1, only the arched portion of the bite interference elements extending radially from the occlusal surface are visible. In some embodiments, the bite interference elements can be sized and positioned to fit substantially in the center portion of the occlusal surface of each tooth, while in other cases the size and position bite interference elements can be adjusted to best interact with an opposing tooth or with bite interference elements located on an opposing aligner or appliance. The number of bite interference elements and dimensions of the bite interference elements can also be customized for each particular application or case, or to fit different tooth sizes. Once the size, dimensions, number, and positioning of the bite interference elements has been determined, a physical model of the patient's dentition can be manufactured (using, for example, a 3D printing process), along with model bite interference elements partially protruding from the occlusal surface of the model, and this model can be used to thermoform a dental appliance that includes integrated bite interference elements. As used herein, the term “virtual bite interference element” is used to describe the bite interference elements within the digital software model, the term “model bite interference element” is used to describe the bite interference elements within the physical model of the patient's dentition that is used as a thermoform model, and the term “bite interference element” is used to describe the bite interference elements within a dental appliance (fabricated using thermoforming techniques, additive manufacturing techniques, or any other suitable fabrication methods).

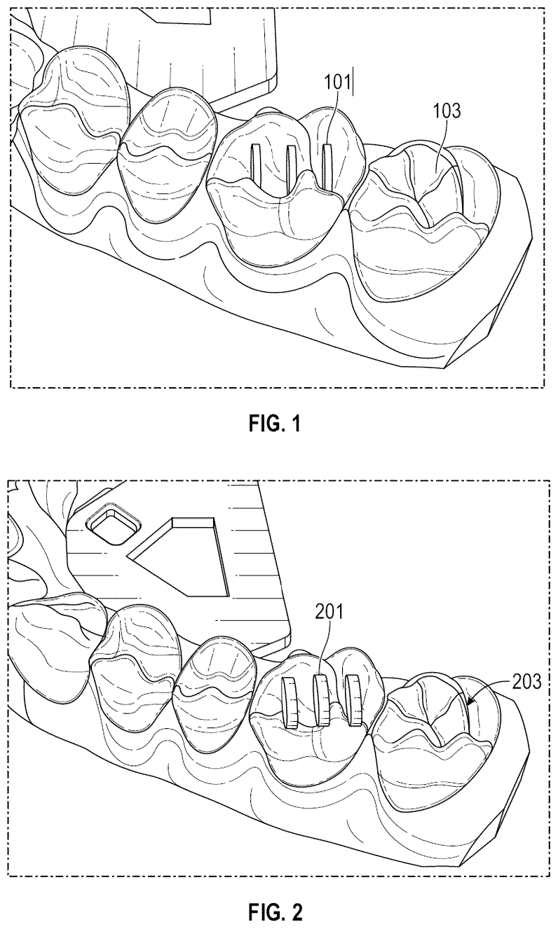

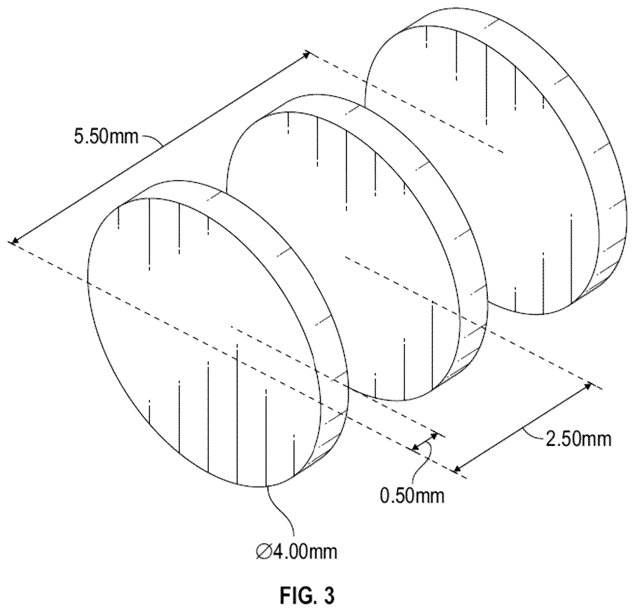

FIG. 2 shows an example digital model of a set of virtual bite interference elements 201 positioned on a posterior tooth within a digital model of a patient's dentition 203, according to an embodiment of the present disclosure. In this embodiment, the digital model of the virtual bite interference elements shows a set of three disc-shaped virtual bite interference elements embedded within the model of the patient's dentition. In the digital model shown in FIG. 2, the entire discs of the virtual bite interference elements are visible, with a portion of the virtual bite interference elements extending radially above the occlusal surface of the tooth model. Depending on the diameter of the discs, as well as the depth of the center of the discs with respect to the occlusal surface of the tooth, more or less of the virtual bite interference elements will extend beyond the occlusal surface.

FIG. 3 shows example dimensions of a set of virtual bite interference elements, according to an embodiment of the present disclosure. In this particular embodiment, each disc has a diameter of about 4.00 mm, a thickness of about 0.5 mm, and each disc is spaced about 2.5 mm from the next. Thus, with three disc-shaped virtual bite interference elements the distance between the outer virtual bite interference elements is about 5.5 mm. In various embodiments, each of the virtual bite interference elements can be spaced between about 0.5 mm, 1.0 mm, 1.5 mm, 2.0 mm, 2.5 mm, or 3.0 mm apart. In various embodiments, each of the virtual bite interference elements can have a diameter between about 3.5 mm to 4.5 mm, and a width between about 0.3 mm to 0.7 mm.

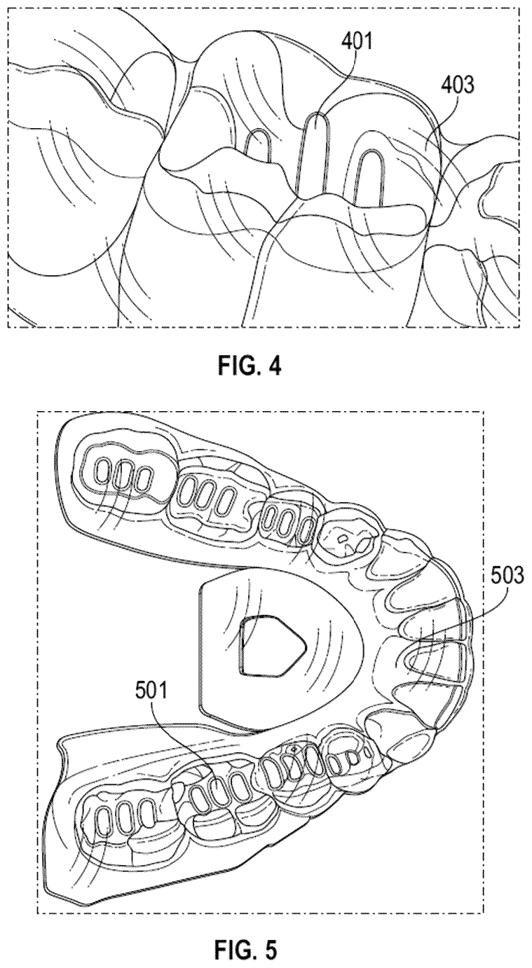

FIG. 4 shows an example of a thermoformed dental appliance 403 including a set of integrated posterior bite interference elements 401, according to an embodiment of the present disclosure. In this example, the polymeric dental appliance 403 is shown after it has been thermoformed over a physical dental model and then removed from the dental model. As discussed above, the dental model may be 3D printed based on a digital model of the patient's dentition, which may also include a physical representation of the bite interference elements 401 (referred to as “model bite interference elements”). Thus, once the polymeric material is thermoformed over the physical dental model, the bite interference elements 401 are formed within the polymeric shell that will constitute the dental appliance. In the example shown in FIG. 4, one of the molars of the dental appliance includes three integrated disc-shaped occlusal bite interference elements.

FIG. 5 shows an example of a thermoformed dental appliance 503 including multiple sets of bite interference elements 501 on various teeth, according to an embodiment of the present disclosure. In this example, a polymeric dental appliance 503 is shown after it has been thermoformed over a physical dental model of the upper teeth and then removed from the dental model. The virtual dental model in this example embodiment included a number of sets of virtual bite interference elements positioned on eight different teeth, with three virtual bite interference elements located on the occlusal surface of each tooth. A set of dental appliances may include two appliances or aligners, with one appliance for the upper teeth (maxillary teeth) and another appliance for the lower teeth (mandibular teeth). Thus, a set of appliances may have additional bite interference elements on the appliance corresponding to the lower or mandibular arch, as well as the maxillary arch.

In the embodiment shown in FIG. 5, the bite interference elements 501 each include a set of three interference elements shaped as discs protruding from the occlusal surface of the dental appliance 503. In some cases, bite interference elements may only be included on the first and/or second molars, rather than on so many posterior teeth. Instructions can be provided in the treatment planning software to indicate to a technician to avoid applying markings (such as laser marks or printed markings) over the bite interference elements, whenever possible.

In order to determine an appropriate bite ramp geometry, an analysis of standard tooth sizes was performed to determine the largest and smallest teeth which bite interference elements may be applied to. A random sample of 40 patient dentitions on file was selected, and molar and pre-molar width and depth were measured. The results of this analysis are provided below in Table 1.

TABLE 1

| Smallest Premolar | | Largest Premolar | | Smallest Molar | | Largest Molar | | |
|---|---|---|---|---|---|---|---|---|
| Width (mm) | Depth (mm) | Width (mm) | Depth (mm) | Width (mm) | Depth (mm) | Width (mm) | Depth (mm) | Age |
| 7 | 9.75 | 8 | 9.5 | 10.5 | 11.5 | 12.3 | 11.75 | teen |
| 7 | 8 | 7.5 | 9.5 | 9.5 | 11.25 | 12 | 10.75 | teen |
| 7.5 | 7.5 | 7.5 | 9.5 | 9.75 | 10 | 11 | 10.5 | teen |
| 7.5 | 7.75 | 8 | 9.75 | 10 | 11.3 | 11 | 10.5 | teen |
| 6.75 | 7.5 | 7 | 8.75 | 9.75 | 10.75 | 11 | 10 | teen |
| 7 | 7 | 6.75 | 8.75 | 8.5 | 8 | 12 | 10.25 | teen |
| 7.5 | 7.5 | 7.5 | 9 | 9 | 10 | 11 | 10.25 | teen |
| 7.5 | 8 | 8 | 9.75 | 11 | 10.5 | 12 | 11 | teen |
| 7.25 | 7.25 | 7.75 | 10 | 10.5 | 10.75 | 10.5 | 11 | teen |
| 7 | 7.75 | 7.25 | 9 | 9.5 | 10.75 | 11 | 10 | teen |
| 7.75 | 8 | 8.25 | 9 | 9 | 11.5 | 11.5 | 11 | teen |
| 6.75 | 6.75 | 7 | 8 | 9.5 | 10 | 11 | 9.5 | teen |
| 7.5 | 8 | 7.5 | 10 | 11 | 11 | 11 | 12.5 | teen |
| 7.75 | 8 | 8 | 8.5 | 9.5 | 11 | 13 | 11.5 | teen |
| 7.5 | 8.25 | 7.75 | 10 | 9.5 | 10.75 | 12.5 | 11 | teen |
| 7 | 8 | 7.5 | 10.5 | 10.25 | 12 | 11.5 | 11 | teen |
| 7.25 | 7 | 8 | 9.5 | 10 | 11 | 11.75 | 10.5 | teen |
| 7.5 | 8.25 | 7.5 | 10 | 11 | 12 | 12 | 10.5 | teen |
| 7.5 | 7.5 | 7.5 | 9.75 | 9.75 | 11.5 | 11 | 10 | teen |
| 6.75 | 8.25 | 7.75 | 7.5 | 10.5 | 10 | 12 | 10.5 | teen |
| 7.5 | 8 | 6.5 | 10 | 9.5 | 12 | 12 | 11.75 | teen |
| 7.5 | 8.25 | 7.25 | 10 | 10.75 | 9 | 11 | 10 | teen |
| 6.75 | 7.75 | 7.25 | 10.5 | 10.75 | 10.25 | 10.75 | 10.25 | teen |
| 7.25 | 7.5 | 7 | 8.5 | 10 | 9.5 | 11.5 | 10 | teen |
| 8 | 8.5 | 8.25 | 8.75 | 10.75 | 11.5 | 12 | 10.75 | senior |
| 6.25 | 7 | 9 | 7.25 | 9.5 | 11 | 11.5 | 10.75 | senior |
| 7 | 7.75 | 7.5 | 9.75 | 10.25 | 11 | 10.5 | 12.5 | senior |
| 7 | 8 | 7.25 | 10 | 11.5 | 12 | 11 | 13 | senior |
| 7 | 7.75 | 6.25 | 11 | 8 | 9.25 | 11 | 10.5 | senior |
| 6.75 | 7.5 | 6.75 | 9 | 9 | 11.25 | 11 | 10 | senior |
| 7.5 | 8 | 7.5 | 9.75 | 8.5 | 12 | 11.5 | 11 | senior |
| 6.5 | 8 | 7 | 9.5 | 8.5 | 11.25 | 10.5 | 10.5 | senior |
| 6.5 | 10 | 8 | 9.75 | 10.25 | 12.5 | 10.5 | 12 | senior |
| 7.5 | 7.5 | 7.75 | 9.5 | 8.5 | 10.25 | 11.5 | 11 | senior |
| 6.5 | 7 | 7.25 | 7.5 | 9 | 10.5 | 11.5 | 10.25 | senior |
| 6.25 | 6.75 | | | | | 13 | 13 | Min/Max |

As can be seen in Table 1, the smallest premolars measured to be 6.25 mm (buccal/lingual)×6.75 mm (mesial/distal), while the largest molars measured to be 13 mm (buccal/lingual)×13 mm (mesial/distal). According to one embodiment, the geometry of the bite interference elements should fit all premolar and molar tooth sizes.

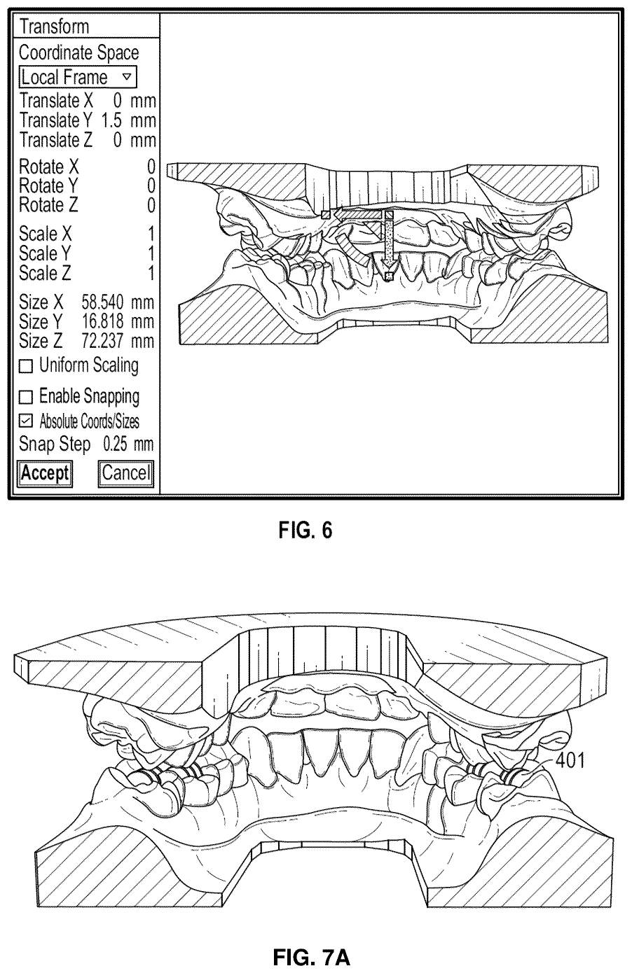

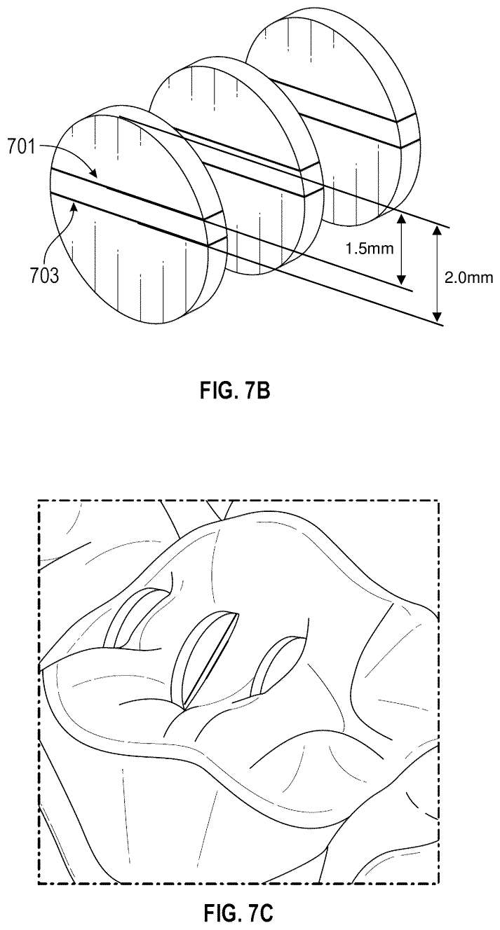

FIG. 6 shows an example user interface for a treatment planning software for determining a size and position of virtual bite interference elements, according to an embodiment of the present disclosure. In this embodiment, a digital model of the patient's dentition is presented along with a set of parameters on the left side that can be used to determine a desired position of the jaws with respect to one another in a number of axes. The Y axis can be adjusted, as shown in FIG. 6, to set a distance of 1.5 mm between the upper and lower arches. These parameters can be used to determine a maximum intercuspation of the dental arch, and thus determine the size and positioning of bite interference elements necessary to achieve the desired jaw position. Once a desired bite spacing has been determined, one or more virtual bite interference elements can be placed within the virtual 3D model, as shown in FIG. 7A, below. As discussed below, this or a similar software user interface can be used in conjunction with a computing device and other treatment planning software in order to virtually design the geometry, position, depth, angle, or any other parameter of the bite interference elements prior to fabrication. This can be done, in some embodiments, by adjusting the vertical and/or lateral spacing between the upper and lower dental arches, the angle of one arch with respect to the other, etc. These adjustments can be made, for example, using touchscreen or other input methods used by a treatment planning technician. In some embodiments, a 3D model of the patient's dentition may then be manufactured and used as a thermoforming model. In other embodiments, the design of the virtual bite interference elements can be used to virtually design a dental appliance that can be fabricated in other ways, such as through direct 3D printing.

According to another embodiment of the present disclosure, the virtual bite interference elements can be placed within the virtual dental model without the need for adjusting the position and orientation of the upper dentition with respect to the lower dentition. In such an embodiment, the virtual bite interference elements can include indicator marks, as described in FIGS. 7B-7C below, and can be positioned within the virtual dental model (either the upper dentition or the lower dentition), based on these indicator marks.

FIG. 7A shows an example digital model of a patient's dentition including multiple sets of virtual bite interference elements, according to embodiments of the present disclosure. In this example embodiment, a set of three disc-shaped virtual bite interference elements are positioned onto the lower dentition on the first and second molars. Thus, a total of twelve virtual bite interference elements are used in this example. In other examples, virtual bite interference elements could be positioned onto more or fewer teeth within the lower dentition (i.e. the mandibular molars), or onto the upper dentition (i.e. the maxillary molars). If virtual bite interference elements are to be positioned onto both the upper and lower dentition, they may need to extend past the occlusal surface less distance in order to achieve the desired bite spacing.

FIG. 7B shows another example digital model of a set of virtual bite interference elements, according to embodiments of the present disclosure. In this example embodiment, the digital models of the disc-shaped virtual bite interference elements include a number of indicator marks 701, 703 located at different distances from their outer circumference. These indicator marks within the digital model of the virtual bite interference elements can be used to properly place the virtual bite interference elements with respect to the occlusal surface of the teeth. For example, in one embodiment the virtual bite interference elements include a first indicator mark 701 located 1.5 mm from the top surface of the virtual bite interference element (the upper edge of the disc along its circumference), and a second indicator mark 703 located 2.0 mm from the top surface of the virtual bite interference element. If it is determined that the virtual bite interference elements corresponding to a certain tooth should extend 1.5 mm from the occlusal surface of the tooth, the elements can be placed at the appropriate depth within the digital model of the tooth until the first indicator mark 701 is at the deepest feature of the tooth. Similarly, if it is determined that the virtual bite interference elements corresponding to a certain tooth should extend 2.0 mm from the occlusal surface of the tooth, the elements can be placed at the appropriate depth within the digital model of the tooth until the second indicator mark 703 is at the deepest feature of the tooth. One skilled in the art will appreciate that the digital or virtual bite interference elements can be implemented with different indicator marks at different positions, and that such indicator marks can be used with different bite interference element geometries. The straight indicator lines shown are used for exemplary and illustrative purposes only, and other markings or designs on the virtual bite interference elements can be used rather than straight lines in order to achieve the same ends. For example, dashed lines, dotted marks, curved lines, or other suitable markings can be used to mark appropriate depths and locations on the virtual bite interference elements, and the claims are not restricted to any particular indicator mark geometry or shape.

FIG. 7C shows an example digital model of a tooth with a set of three virtual bite interference elements, according to embodiments of the present disclosure. In this particular embodiment, the bite spacing for the tooth shown requires that the virtual bite interference element should extend 2.0 mm from the deepest occlusal surface of the tooth. Thus, according to the virtual bite interference elements shown in FIG. 7B which include indicator marks at 1.5 mm and 2.0 mm, the elements are placed at the appropriate depth within the tooth until the second indicator mark located at 2.0 mm is at the deepest feature of the tooth. In this embodiment, since the peaks of each of the virtual bite interference elements are located in a single plane, and each tooth includes fossa and ridges, each of the virtual bite interference elements may extend different heights beyond the occlusal surface of the tooth.

In some embodiments, because the upper and lower dentition move with respect to one another according to a mandibular rotation from the temporomandibular joint, the more posterior molars may require less prominent bite interference elements compared to the first molar and the premolars. Thus, in order to maintain the same bite spacing between the upper and lower dentition, the height of the virtual bite interference elements on the second molar may be less than the height of the virtual bite interference elements on the first molar and the premolars. For example, the virtual bite interference elements on the second molars can be set to a height of 1.5 mm, while the virtual bite interference elements on the first molar and premolars can be set to 2.0 mm. In various embodiments, virtual bite interference elements can be placed at one or more teeth, and when virtual bite interference elements are placed on several molars and/or premolars, the height of these elements can depend on the desired bite spacing as well as the position of the tooth within the mouth (e.g., whether the tooth is a first molar, second molar, or premolar).

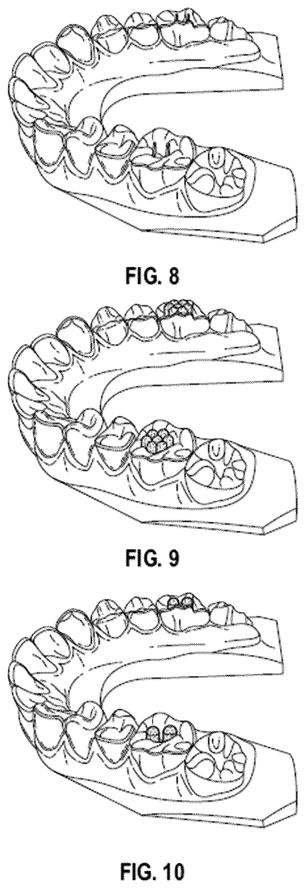

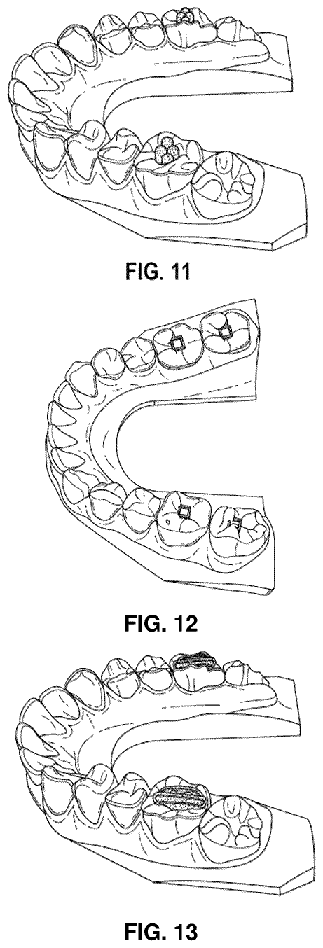

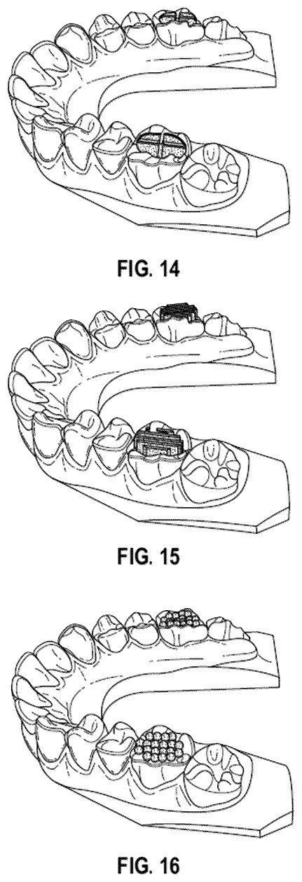

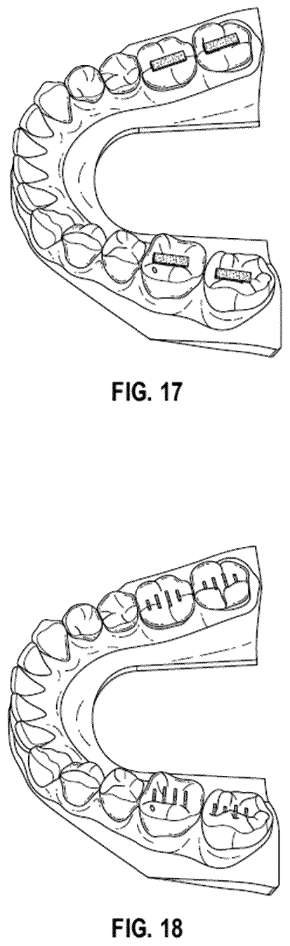

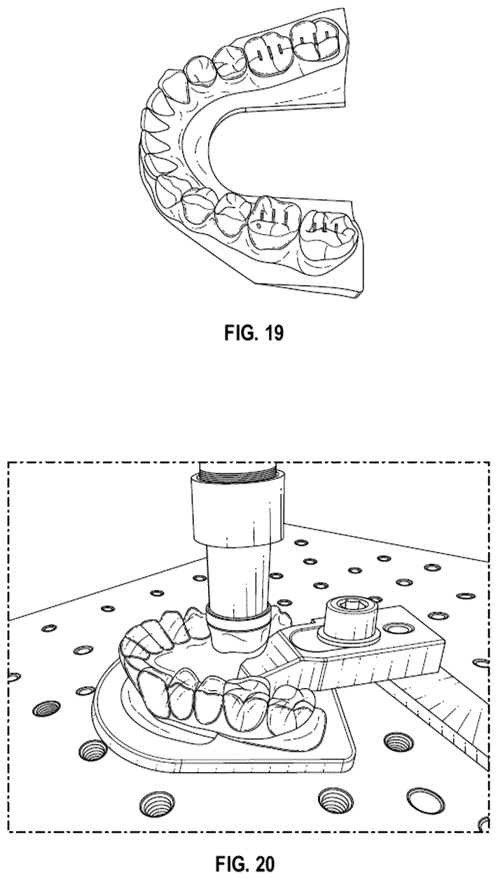

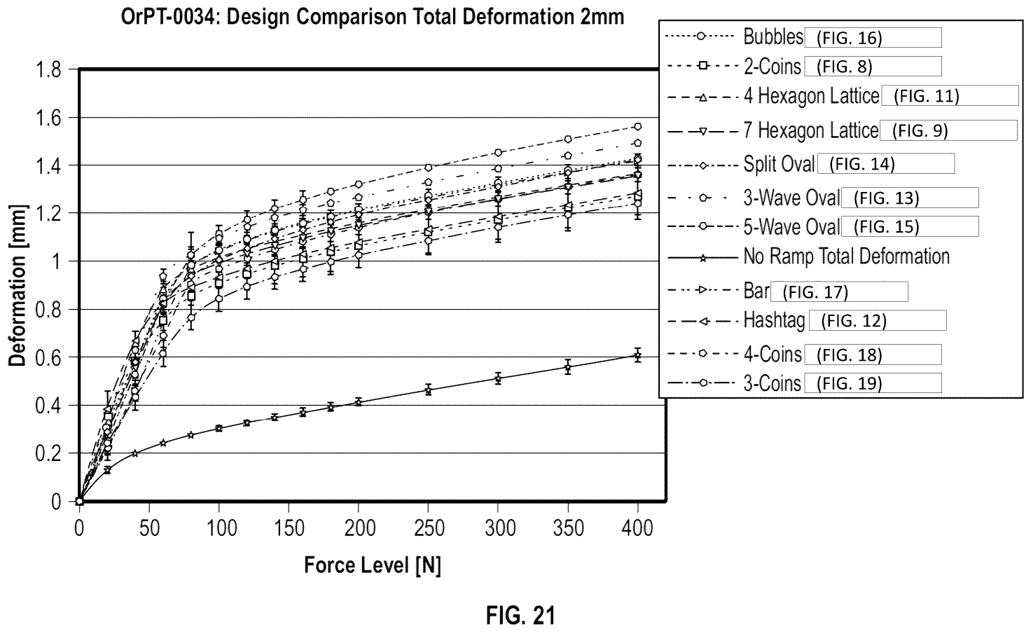

FIGS. 8-19 show example digital models of various virtual bite interference element geometries, according to embodiments of the present disclosure. FIG. 8 shows an embodiment with two disc-shaped or coin-shaped virtual bite interference elements positioned on the second molars of the lower dentition. This example geometry could accommodate all tooth sizes and also minimizes the footprint of the bite interference elements.

FIG. 9 shows an embodiment where a seven bubbles or orbs are arranged in a lattice structure on the second molars of the lower dentition to form a virtual bite interference element. The size of this example geometry may need to be reduced in order to fit within premolars. Each of the bubbles may be arranged to level to a single reference point, in some embodiments, such that the bubbles do not follow the natural fossa/cusps of the teeth.

FIG. 10 shows an embodiment where two bubbles are arranged on the second molars of the lower dentition to form a virtual bite interference element This example geometry could also accommodate all tooth sizes and also minimizes the footprint of the bite interference elements.

FIG. 11 shows an embodiment where four bubbles are arranged in a lattice on the second molars of the lower dentition to form a virtual bite interference element. This geometry is designed to accommodate all tooth sizes. Each of the bubbles may be arranged to level to a single reference point, in some embodiments, such that the bubbles do not follow the natural fossa/cusps of the teeth.

FIG. 12 shows an embodiment where a hashtag virtual bite interference element is formed on the first and second molars of the lower dentition. This geometry was designed based on the positive test results from the disc-shaped design, and can be adjusted to fit any tooth size.

FIGS. 13-15 show various geometries intended to mimic the shape of composite bite blockers that are bonded to a patient's teeth with traditional fixed appliances. These designs contain various ridges aimed at improving structural strength, and their geometries can be adjusted to fit premolars or small molars. FIG. 13 shows an oval design with three waves or ridges, FIG. 14 shows a split oval design, and FIG. 15 shows an oval design with five waves or ridges.

FIG. 16 shows an embodiment where a number of bubbles are positioned in a lattice structure on the second molars of the lower dentition to form a virtual bite interference element. In this embodiment, the deformation was found to be significantly more than several of the other geometries. Thus, this design is not preferred especially when compared to other geometries, including the disc-shaped geometries.

FIG. 17 shows an embodiment where a rectangular virtual bite interference element (i.e. a bar) is formed on the first and second molars of the lower dentition. This geometry may utilize or imitate the shape of a rectangular orthodontic engager or attachment, which is often located on the buccal surface of an appliance.

FIG. 18 shows an embodiment with four disc-shaped or coin-shaped virtual bite interference elements positioned on the first and second molars of the lower dentition. In this embodiment, the apex or peak of each of the virtual bite interference elements are located in a single plane, meaning that the virtual bite interference elements do not follow the cusps and fossa of the individual tooth.

FIG. 19 shows an embodiment with three disc-shaped or coin-shaped virtual bite interference elements positioned on the first and second molars of the lower dentition. In this embodiment, the apex or peak of each of the virtual bite interference elements within a single tooth are located in a single plane, meaning that the virtual bite interference elements do not follow the cusps and fossa of the individual teeth.

FIG. 20 shows an example thermoformed dental appliance with bite interference elements undergoing stress testing, according to embodiments of the present disclosure. For these stress tests, various geometries of bite interference elements discussed above were placed over a standard model of a dental arch. Further description of the parameters and results of the stress tests are discussed in reference to FIG. 21 below.

FIG. 21 shows a graph of the deformation of different bite interference element geometries at different force levels, according to embodiments of the present disclosure. For this benchtop test, various geometries were tested with an extrusion of 2 mm, meaning that each bite ramp feature was designed to extend beyond the occlusal surface of the teeth by 2 mm from the deepest part of the molar. The test appliances were thermoformed using ClearQuartz material from Bay Materials, LLC using a Biostar pressure molding machine at standard settings. Prior to testing, the dental appliances were aged in 37° C. water for 24 hours to simulate the conditions within a patient's mouth. The test probe was outfitted with a molar cap, and pressures were applied to the bite interference elements. All appliances were tested under increasing force-controlled cyclic loading (20N, 40N, 60N, . . . , 380N, 400N). For each force level, the force was held for a period between 0-10 seconds. Assessments were made of the displacement values at each force level. Based on this assessment, designs with less displacement were considered stronger.

The graph of deformation values for various geometries is shown in FIG. 21, with the total deformation with no bite interference elements shown at the bottom between 0.0 and 0.6 mm of deformation. Of the appliances tested with bite interference elements, the least deformation at each force level was found to be in appliances with three coin-shaped bite interference elements per tooth, as discussed and shown above in FIGS. 1-2.

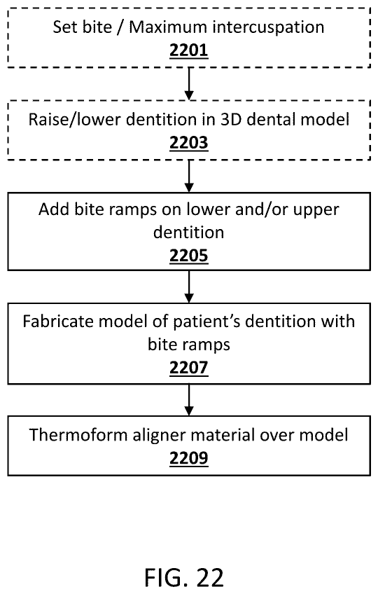

FIG. 22 depicts a flow diagram of a method for fabricating an integrated posterior bite interference element, according to embodiments of the present disclosure. Although specific function blocks are disclosed, such blocks are examples, and one skilled in the art will appreciate that additional or fewer steps may be implemented in various embodiments, and the order of the function blocks may also be adjusted within the scope of the invention, unless specified otherwise. As such, the blocks may be performed in an order different than presented, and not all of the blocks may necessarily be performed.

At block 2201, the bite or maximum intercuspation is set. As discussed above, in some embodiments, a treatment planning technician can utilize a user interface and treatment planning software to adjust the orientation and spacing of the upper and lower arches with respect to one another, as depicted for example in FIG. 6, above.

At block 2203, the upper and/or lower dentition in the 3D model of the patient's dentition is raised or lowered to achieve the desired bite spacing. In some embodiments, this can also be done using the user interface and treatment planning software discussed herein.

At block 2205, the virtual bite interference elements are added to the lower and/or upper dentition within the 3D model. As discussed above, various different geometries, shapes, sizes, orientations etc. can be used for the virtual bite interference elements depending on the individual case and the size of the patient's teeth. The positioning of the virtual bite interference elements with respect to the occlusal surface of the 3D model may also consider the thickness of the particular thermoplastic being used in order to achieve the desired bite spacing. For example, when using a thinner thermoplastic to fabricate a dental appliance, to achieve a particular spacing between the occlusal surfaces of opposing molars in a patient's upper and lower dentition the virtual bite interference elements may extend more beyond the occlusal surface within the 3D model, when compared to a treatment plan using a thicker thermoplastic.

In some embodiments, blocks 2201 and 2203 are optional and not required to fabricate integrated posterior bite interference elements. In embodiments where blocks 2201 and 2203 are not performed, the method can begin with adding the virtual bite interference elements to the lower and/or upper dentition within the 3D model at block 2205. In one such embodiment, the virtual bite interference elements can include indicator marks, as discussed above, and the proper placement of the bite interference elements with respect to the occlusal surface of the teeth can be achieved using these indicator marks. In some embodiments, the distance that the virtual bite interference elements extend beyond the occlusal surface of the teeth can vary depending on the tooth in order to achieve a desired bite spacing. For example, the virtual bite interference elements associated with the second molars can extend less beyond the occlusal surface of the second molars compared to the virtual bite interference elements associated with the first molars or premolars.

At block 2207, a 3D model of the patient's dentition, including the model bite interference elements, is fabricated. This model can then be used to thermoform an appliance material at block 2209 to fabricate a shell of a dental appliance. One skilled in the art will be appreciated that additional processing steps, including cutting, marking, packaging, etc. would be performed after block 2209 in order to fabricate a final dental appliance suitable for shipment to a patient.

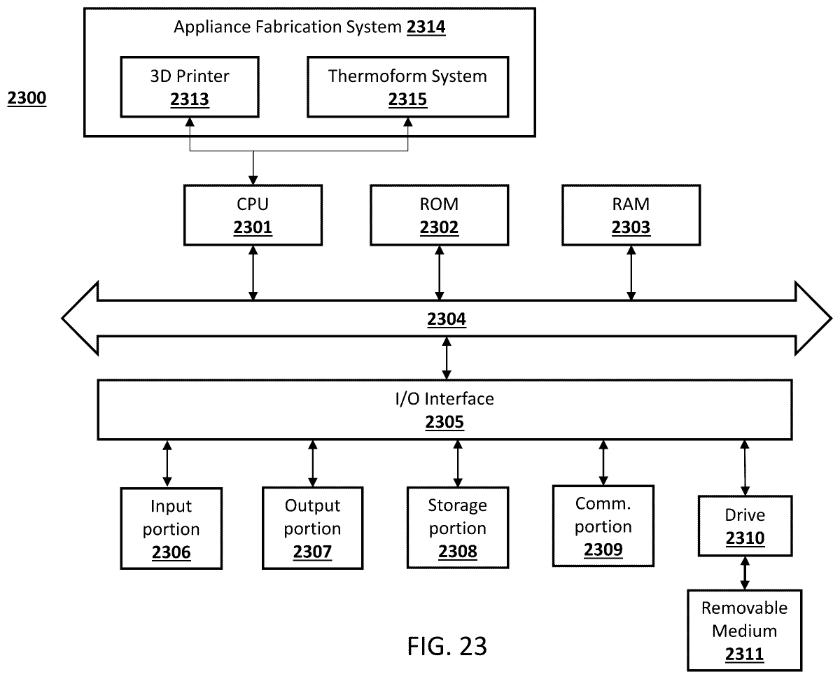

Referring to FIG. 23, a schematic structural diagram of a computer system 2300 adapted to implement a computing system, according to embodiments of the present disclosure. The computing system described below may be designed to implement the methods disclosed herein.

As shown in FIG. 23, a computer system 2300 may include a central processing unit (CPU) 2301, which may execute various actions and processes in response to the execution of a program stored in a read-only memory (ROM) 2302 or a program loaded into a random access memory (RAM) 2303 from a storage portion 2308. The RAM 2303 also may store various programs and data required by operations of the system 2300. The CPU 2301, ROM 2302 and RAM 2303 may be connected to each other through a bus 2304, in some embodiments. An input/output (I/O)) interface 2305 (e.g., a touch screen, keyboard, mouse, microphone with voice recognition capabilities, etc.) can also be connected to the bus 2304. The bus 2304 may include one or more buses connected to each other through various bridges, controllers and/or adapters as is well known in the art. The CPU 2301 may be in communication with a dental appliance fabrication system 2314, which may include, in some embodiments, a 3D printer 2313, a thermoform system 2315, or any other necessary components required for downstream manufacturing and processing of the dental appliances discussed herein. In other embodiments, the appliance fabrication system 2314 may include a direct 3D printing system that can directly fabricate a dental appliance having the bite interference elements disclosed herein.

In some embodiments, the input portion 2306 (e.g., keyboard, touchscreen, mouse, etc.), output portion 2307 (e.g., speaker, screen, etc.), storage portion 2308 (e.g., hard disk, flash drive, etc.), and communication portion 2309 (e.g., network interface card, etc.) are all connected to the I/O interface 2305. The communication portion 2309 can perform communication processes via a network, such as the Internet. A drive 2310 can also be connected to the I/O interface 2305 as needed. A removable medium 2311, such as a magnetic disk, an optical disk, a magneto-optical disk, a flash drive, etc., may be placed on the drive 2310, to enable the retrieval of a computer program from the removable medium 2311, and the installation thereof on the storage portion 2308 as needed.

According to one embodiment of the present disclosure, the process described above with reference to FIG. 22 may be implemented in a computer software program. For example, an embodiment of the present disclosure includes a computer program product, which comprises a computer program that is tangibly embedded in a machine-readable medium. The computer program comprises program codes for executing the method of FIG. 22. In such an embodiment, the computer program may be downloaded and installed from a network via the communication portion 2309, and/or may be installed from the removable media 2311.

It will be appreciated that the present invention may utilize a nonvolatile memory which is remote from the system, such as a network storage device which is coupled to the data processing system through a network interface such as a modem, an Ethernet interface or a wireless network.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

1. A dental appliance, comprising:
at least one polymeric shell having a plurality of cavities shaped to fit over a patient's teeth, the polymeric shell including an occlusal appliance surface shaped to fit over an occlusal tooth surface; and
one or more bite interference elements, each bite interference element formed in the occlusal appliance surface and including a partially disc-shaped feature extending radially away from the occlusal tooth surface when worn by a patient.

2. The dental appliance of claim 1, wherein the one or more bite interference elements provide a displacement between upper and lower teeth when worn by the patient.

3. The dental appliance of claim 1, wherein the one or more bite interference elements include three partially disc-shaped features positioned in the occlusal appliance surface corresponding to a single molar or premolar.

4. The dental appliance of claim 3, wherein each bite interference element positioned in the occlusal appliance surface corresponding to a single molar or premolar is spaced between about 1.0 mm and 3.0 mm apart.

5. The dental appliance of claim 3, wherein each bite interference element positioned in the occlusal appliance surface corresponding to a single molar or premolar has an apex located in a single plane.

6. The dental appliance of claim 1, wherein the partially disc-shaped feature of each of the one or more bite interference elements has a diameter of between about 3.5 mm to 4.5 mm.

7. The dental appliance of claim 1, wherein the disc-shaped feature of each of the one or more bite interference elements has a width of between about 0.3 mm to 0.7 mm.

8. The dental appliance of claim 1, wherein the one or more bite interference elements include a plurality of bite interference elements formed in the occlusal appliance surface of a plurality of adjacent teeth.

9. A method of forming a dental appliance, comprising:
positioning one or more virtual bite interference elements on an occlusal surface of one or more teeth within a virtual three-dimensional (3D) model of a patient's dentition, each virtual bite interference element including a disc-shaped feature partially extending radially away from the occlusal surface:
fabricating a physical model of the patient's dentition based on the virtual 3D model, the physical model including one or more model bite interference elements corresponding to the one or more virtual bite interference elements; and
thermoforming a thermoplastic material over the physical model of the patient's dentition to form a dental appliance having one or more bite interference elements corresponding to the model bite interference elements.

10. The method of claim 9, wherein fabricating the physical model of the patient's dentition includes 3D printing the physical model of the patient's dentition.

11. The method of claim 9, wherein the one or more bite interference elements provide a displacement between upper and lower teeth when worn by the patient.

12. The method of claim 9, wherein the one or more bite interference elements include three partially disc-shaped features positioned in an occlusal appliance surface corresponding to a single molar or premolar.

13. The method of claim 12, wherein each virtual bite interference element is spaced between about 1.0 mm and 3.0 mm apart.

14. The method of claim 12, wherein each virtual bite interference element has an apex located in a single plane.

15. The method of claim 9, wherein each virtual bite interference element has a diameter of between about 3.5 mm to 4.5 mm.

16. The method of claim 9, wherein each virtual bite interference element has a width of between about 0.3 mm to 0.7 mm.

17. The method of claim 9, wherein positioning the one or more virtual bite interference elements includes positioning a plurality of virtual bite interference elements in the occlusal surface of a plurality of adjacent teeth within the virtual 3D model.

18. The method of claim 9, wherein positioning the one or more virtual bite interference elements includes positioning a first set of virtual bite interference elements in the occlusal surface of a second molar and a second set of virtual bite interference elements in the occlusal surface of a first molar or premolar, wherein the second set of virtual bite interference elements extends beyond an occlusal surface of the first molar or premolar more than the second set of virtual bite interference elements extends beyond an occlusal surface of the second molar.

19. A system, comprising:
a dental appliance fabrication system configured to fabricate a dental appliance; and
a computing system in communication with the dental appliance fabrication system, the computing system configured to:
receive three-dimensional (3D) scan data representing a patient's dentition;
generate a virtual 3D model of the patient's dentition;
position one or more virtual bite interference elements on an occlusal surface of one or more teeth within the virtual 3D model of the patient's dentition, each virtual bite interference element including a disc-shaped feature partially extending radially away from the occlusal surface;
provide instructions to the dental appliance fabrication system to fabricate a dental appliance including one or more model bite interference elements corresponding to the one or more virtual bite interference elements.

20. The system of claim 19, wherein the dental appliance fabrication system includes:
a three-dimensional (3D) printing system configured to fabricate a physical dental model of the virtual 3D dental model; and
a thermoforming system configured to thermoform a thermoplastic over the physical dental model to form a dental appliance having one or more bite interference elements corresponding to the one or more model bite interference elements.
